(19) United States
(12) Patent Application Publication
(10) Pub. No.: US 2025/0336080 A1
(43) Pub. Date: Oct. 30, 2025

(54) METHODS AND APPARATUS FOR REAL-TIME INTERACTIVE PERFORMANCES

(71) Applicant: Intel Corporation, Santa Clara, CA (US)

(72) Inventors: Shandong WANG, Beijing (CN); Yurong CHEN, Beijing (CN); Anbang YAO, Beijing (CN); Yuxin HE, Beijing (CN); Jianbing ZHU, Beijing (CN); Lin XIE, Beijing (CN); Guanghao ZHENG, Beijing (CN); Nana ZHANG, Beijing (CN); Ming LU, Beijing (CN); Dongqi CAI, Beijing (CN)

(73) Assignee: Intel Corporation, Santa Clara, CA (US)

(21) Appl. No.: 18/870,178

(22) PCT Filed: Jun. 30, 2022
(86) PCT No.: PCT/CN2022/102699

§ 371 Date: Nov. 27, 2024

(51) Int. Cl. G06T 7/70; G06V 10/25; G06V 20/52

(52) U.S. Cl. CPC G06T 7/70; G06V 10/25; G06V 20/52; G06T 2207/30196; G06V 2201/07

(57) ABSTRACT

Methods, apparatus, systems, and articles of manufacture are disclosed for real-time interactive performances. An example apparatus includes at least one memory, machine readable instructions, and processor circuitry to at least one of instantiate or execute the machine readable instructions to capture an image of a performance area, detect one or more performers in the performance area using the image, estimate locations of the one or more detected performers, smooth the estimated locations of the one or more detected performers based on prior estimated locations, and provide the smoothed estimated locations to display controller circuitry for generation of an interactive effect based on the smoothed estimated locations

### FIELD OF THE DISCLOSURE

This disclosure relates generally to interactive performances and, more particularly, to methods and apparatus for real-time interactive performances.

### BACKGROUND

In a theatrical performance, one or more performers move about a stage or other performance area in front of an audience. Such performances may range in scale from small scale performances, involving only a few performers, all the way up to large scale performances, involving tens or hundreds of performers.

### BRIEF DESCRIPTION OF THE DRAWINGS

FIG. 1 is representation of a large scale interactive theatrical performance.

FIG. 2 is a close-up representation of an alternate large scale interactive performance.

FIG. 3 is a second alternate view of the large scale interactive performance of FIG. 2.

FIG. 4 is a block diagram representing an example environment of use for an interactive presentation system for real-time interactive performances.

FIG. 5 is a block diagram representing an example implementation of the example position detection circuitry of FIG. 4.

FIG. 6 is a block diagram representing an example implementation of the example display controller circuitry of FIG. 4.

FIG. 7 is a flowchart representative of example machine readable instructions and/or example operations that may be executed by example processor circuitry to implement the display controller of FIG. 4.

FIG. 8 is a flowchart representative of example machine readable instructions and/or example operations that may be executed by example processor circuitry to implement the position detection circuitry of FIG. 4.

FIG. 9 is a plan view representation of the example system of FIG. 4.

FIG. 10 depicts positioning of the example position detection circuitry of FIGS. 4 and/or 5.

FIG. 11 is an illustration of a region of interest (ROI) mask.

FIG. 12 illustrates an example vantage point of the example position detection circuitry of FIGS. 4 and/or 5 with respect to a stage.

FIG. 13 is a representation of a homograph matrix.

FIG. 14 is a flowchart representative of example machine readable instructions and/or example operations that may be executed by example processor circuitry to implement the position detection circuitry of FIG. 4.

FIG. 15 is a representation of an interactive performance, including person detection information.

FIG. 16 is a representation of location detection of a person based on a bounding box position.

FIG. 17 is a flowchart representative of example machine readable instructions and/or example operations that may be executed by example processor circuitry to implement the display controller of FIG. 4.

FIG. 18 illustrates an example ROI definition for a first camera, including a first overlap region.

FIG. 19 illustrates an example ROI definition for a second camera that is adjacent to the first camera of represented in connection with FIG. 18, including a second overlap region.

FIG. 20 is an example rendering of an interactive performance.

FIG. 21 is a block diagram of an example processing platform including processor circuitry structured to execute the example machine readable instructions and/or the example operations of FIG. 3 to implement the example position detection circuitry and/or the example display controller circuitry of FIG. 4.

FIG. 22 is a block diagram of an example implementation of the processor circuitry of FIG. 21.

FIG. 23 is a block diagram of another example implementation of the processor circuitry of FIG. 21.

FIG. 24 is a block diagram of an example software distribution platform (e.g., one or more servers) to distribute software (e.g., software corresponding to the example machine readable instructions of FIGS. 7, 8, 14, 17) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

Theatrical performances can often benefit from interactivity. For example, when a performer moves about a stage or performance area, it is desirable that a real-time interaction happens between the performer and electronic elements of the performance area. For example, the stage (e.g., the floor of the performance area) may be capable of displaying images or causing other interactive events. Such display may be the result of the stage being made of a light emitting diode screen, or additionally or alternatively may be the result of projected imagery (e.g., from an external light source such as a projector).

In a large scale performance, it is desirable for the real-time graphics and/or imagery to follow the performers. Real-time and accurate person position tracking is necessary for such interaction. One possible approach to detecting the position of a person is the use of a ground screen embedded with pressure sensors. However, such an approach usually has an extremely high production cost and is, therefore, undesirable. An alternative approach is the use of infra-red markers or global-positioning sensors worn by the performer(s). Such an approach is also undesirable, as it is limited in its spatial extent.

Example approaches disclosed herein utilize cameras or video information and artificial intelligence to perform person tracking for use in ultra-large performances and live broadcast scenarios. Example approaches disclosed herein utilize computer vison and artificial intelligence algorithms for multi-person position tracking on a large performance stage, achieving the great advantages of low cost and ease of use. While example approaches disclosed herein are described in the context of an artistic performance, such approaches may be equally applicable to other performances such as, for example, sporting events. Alternatively, such approaches may additionally or alternatively be used for non-performance events to, for example, provide interactivity situations (e.g., on the street).

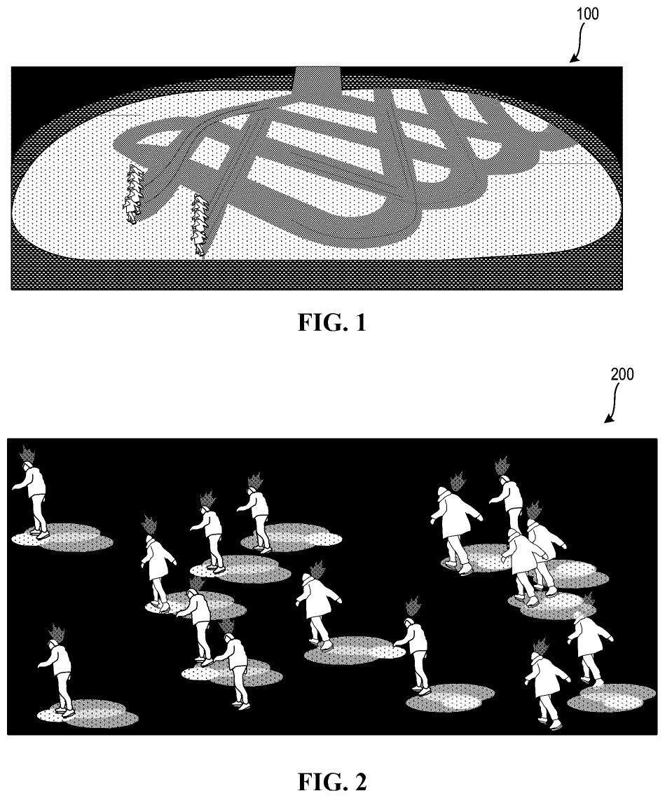

FIG. 1 is representation 100 of a large scale interactive theatrical performance. The illustrated example of FIG. 1 represents a performance entitled “Tributes to the People”, which was performed at the opening ceremony of the Beijing 2022 Winter Olympics. In this performance, twenty four performers moved about the performance area to “push away” the snow and gradually show the trajectory pathways behind the performers. The animation effects in this performance were driven by the real-time tracking of the positions of the performers.

FIG. 2 is a close-up representation 200 of an alternate large scale interactive performance. The illustrated example of FIG. 2 illustrates a performance of “Snowflakes,” which was also performed at the opening ceremony of the Beijing 2022 Winter Olympics. In this performance, more than six hundred performers, each holding a toy pigeon, performed on the stage with free movement. Based on the detected positions of the performers, snowflake effects were displayed on the stage.

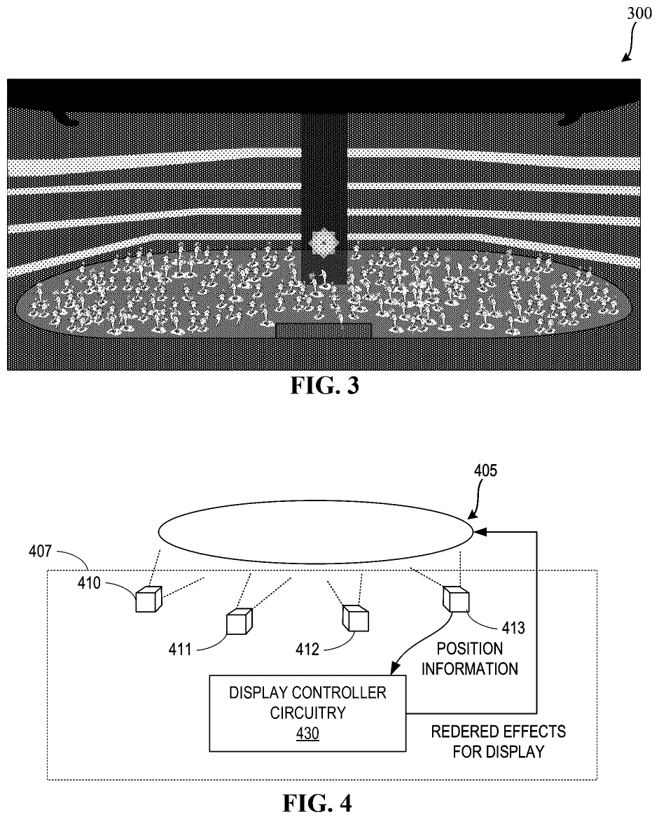

FIG. 3 is a second alternate view 300 of the large scale interactive performance of FIG. 2. In the illustrated example of FIG. 3, the six hundred performers are shown on the stage, each having a snowflake effect displayed in proximity of the performer.

FIG. 4 is a block diagram representing an example environment of use for an interactive presentation system 407 for real-time interactive performances. The example environment of use 400 includes a performance area 405, and the interactive presentation system. The example interactive presentation system 407 includes a plurality of position detection circuitry 410, 411, 412, 413, and display controller circuitry 430. In some examples, the interactive presentation system 407 includes display circuitry for outputting graphics and/or interactive elements at the direction of the display controller circuitry 430.

In the illustrated example of FIG. 4, the performance area 405 is a stage upon which performers are able to stand. In the examples of FIGS. 1, 2, and 3, the stage was sized over ten thousand square meters. However, such large stage sized need not be used for all performances. Moreover, while examples disclosed herein are described in the context of a stage performance, other types of performances such as, for example, sporting events might also be used. In some examples, the performance area 405 includes display circuitry including, for example, light emitting diodes (LEDs) to enable interactive elements to be displayed. That is, the display circuitry may be a component of the performance area 405, as opposed to a component of the interactive presentation system 407. In some examples, projection display circuitry might additionally or alternatively be used to facilitate the display of interactive elements.

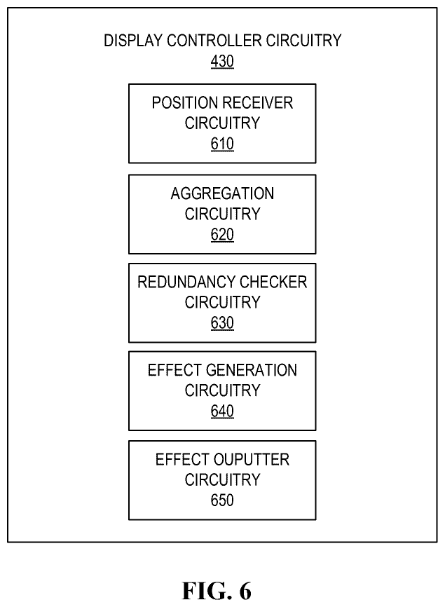

The example position detection circuitry 410, 411, 412, 413 represent cameras placed about the performance area 405. Each position detection circuitry will have a specific zone of the performance area for which it is to capture images. The position detection circuitry 410, 411, 412, 413 processes the captured images to identify position(s) of performer(s) in its respective zone of the performance area, and provides the position information to the display controller circuitry 430. In the illustrated example of FIG. 4, four position detection circuitries 410, 411, 412, 413 are shown. However, any number of position detection circuitries 410, 411, 412, 413 may additionally or alternatively be used based on, for example, the placement availability of cameras to adequately capture images of the entire performance area 405. For example, in a small theater, it may be possible to use one or two position detection circuitries, whereas in a sports arena three position detection circuitries may be used to ensure all of the performance area is captured. An example implementation of the example position detection circuitry is disclosed in FIG. 6, below.

The example display controller circuitry 430 receives position information from the position detection circuitry(ies) 410, 411, 412, 413, aggregates the position information, and generates rendering effects for display. An example implementation of the example display controller circuitry 430 is disclosed in connection with FIG. 6, below.

In the illustrated example of FIG. 4, a single display controller 430 is used and four position detection circuitries 410, 411, 412, 413 are used. In some examples, it may be advantageous to use multiple display controllers and/or multiple position detection circuitries operating on a same zone of the performance area. Such an approach provides redundancy in the event of a failure.

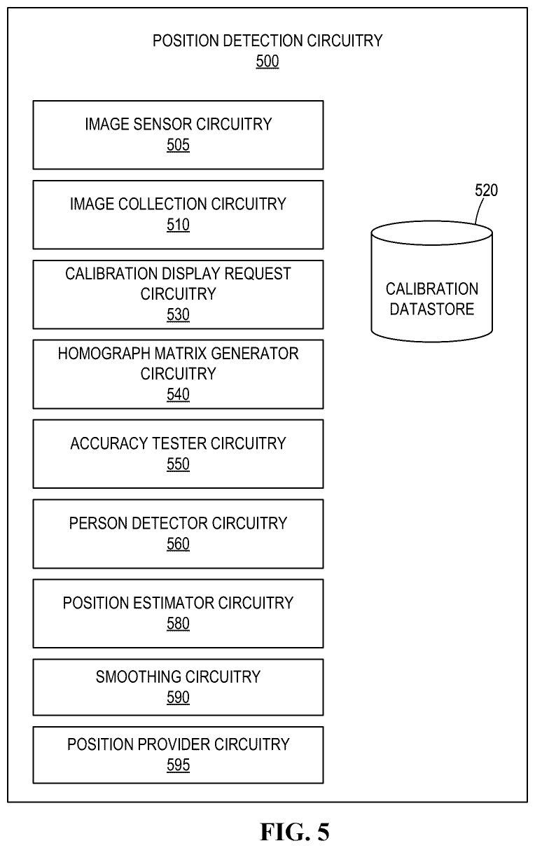

FIG. 5 is a block diagram representing an example implementation of the example position detection circuitry 500 of FIG. 4. The example position detection circuitry 500 of the illustrated example of FIG. 5 includes an image sensor 505, image collection circuitry 510, a calibration datastore 520, a calibration display request circuitry 530, homograph matrix generator circuitry 540, accuracy tester circuitry 550, person detector circuitry 560, position estimator circuitry 580, smoothing circuitry 590, and position provider circuitry 595. The position detection circuitry 500 of FIG. 5 may be instantiated (e.g., creating an instance of, bring into being for any length of time, materialize, implement, etc.) by processor circuitry such as a central processing unit executing instructions. Additionally or alternatively, the position detection circuitry 500 of FIG. 5 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 5 may, thus, be instantiated at the same or different times. Some or all of the circuitry may be instantiated, for example, in one or more threads executing concurrently on hardware and/or in series on hardware. Moreover, in some examples, some or all of the circuitry of FIG. 5 may be implemented by microprocessor circuitry executing instructions to implement one or more virtual machines and/or containers.

The example image sensor 505 of the illustrated example of FIG. 5 is implemented by one or more cameras. In examples disclosed herein, the cameras detect visible light, and convert the visible light into an image. In some examples, the image sensor 505 includes one or more lenses that enable a region of interest of a performance area to be captured.

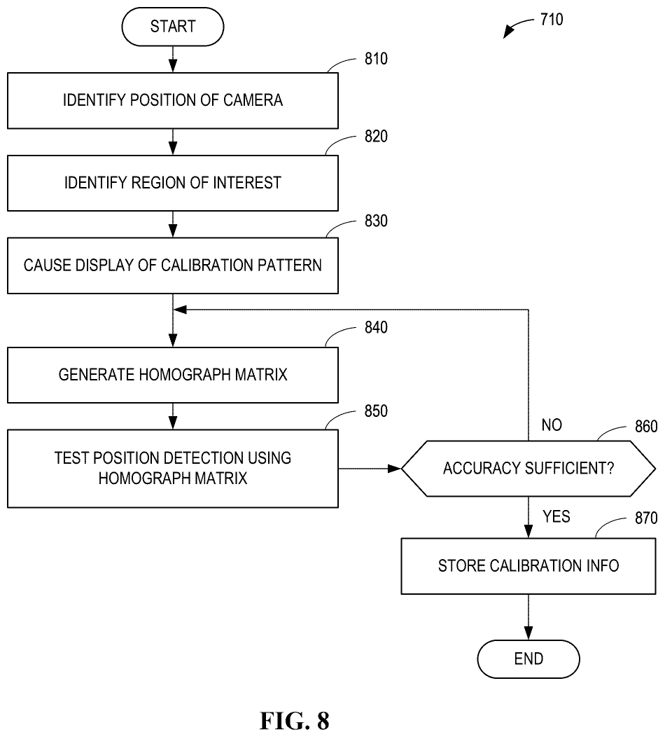

The example image collection circuitry 510 of the illustrated example of FIG. 5 interacts with the image sensor 505 to collect images. During a calibration process, the example the image collection circuitry 510 identifies a position of the camera with respect to the performance area. The example image collection circuitry 510 then identifies a region of interest in an image of the performance area. Images captured by the image collection circuitry 510 are cropped using the ROI mask, resized to an appropriate input size (e.g., 1280×960), and are then used by the person detector circuitry 560 during operation to detect a location of a performer. In some examples, the image collection circuitry 510 is instantiated by processor circuitry executing image collection instructions and/or configured to perform operations such as those represented by the flowchart of FIG. 8.

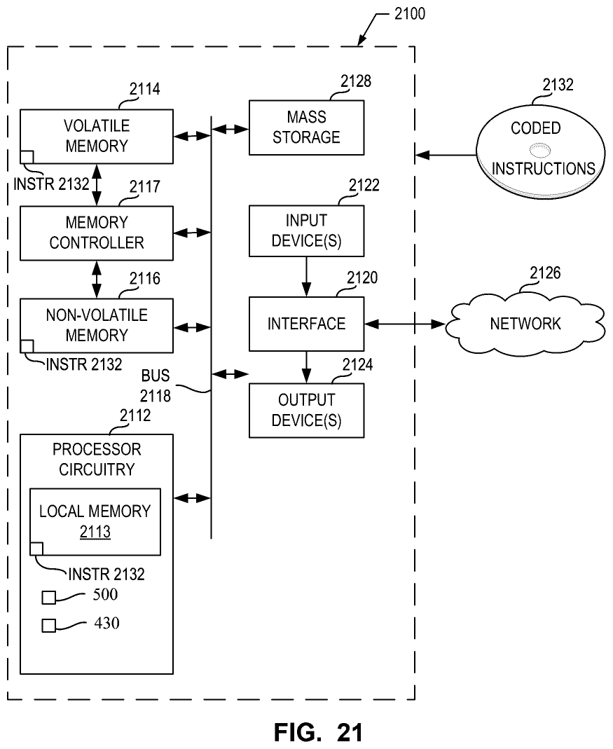

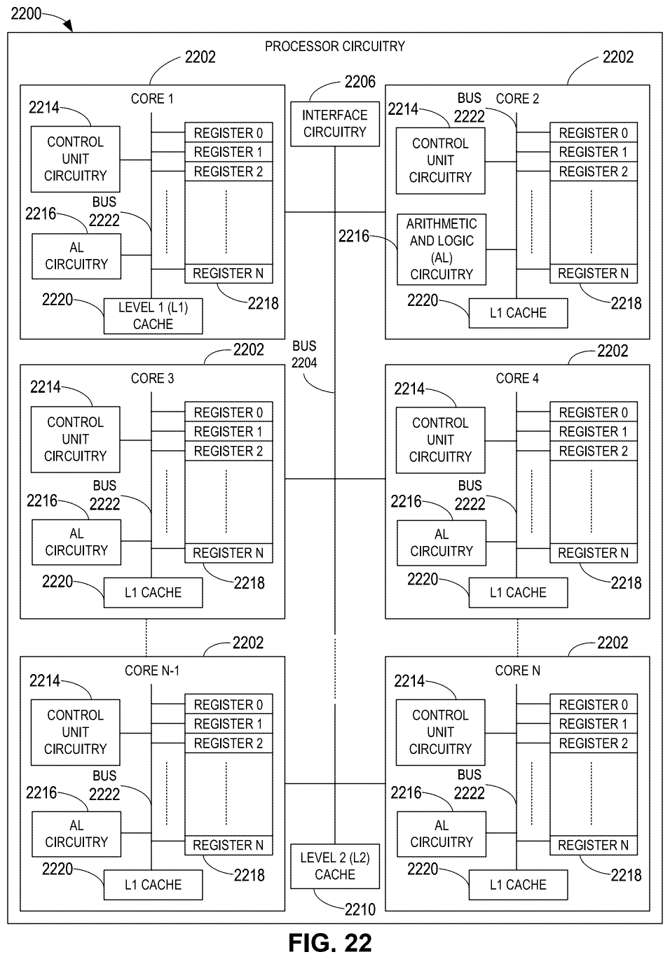

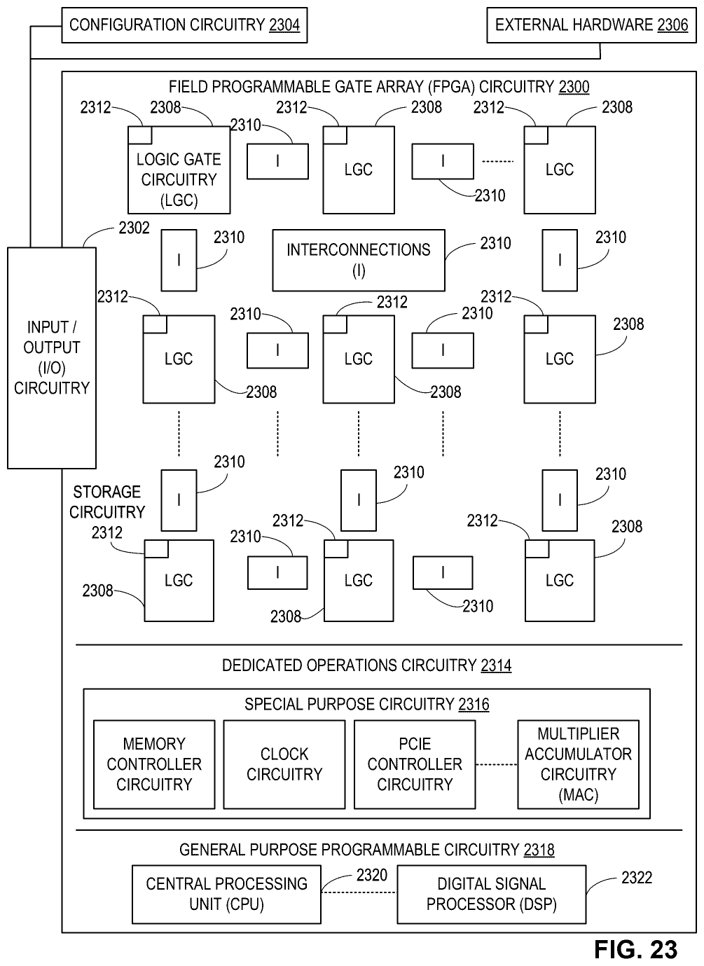

In some examples, the position detection circuitry 500 includes means for collecting. For example, the means for collecting may be implemented by example image collection circuitry 510. In some examples, the image collection circuitry 510 may be instantiated by processor circuitry such as the example processor circuitry 2112 of FIG. 21. For instance, image collection circuitry 510 may be instantiated by the example microprocessor 2200 of FIG. 22 executing machine executable instructions such as those implemented by at least blocks 810, 820. In some examples, the image collection circuitry 510 may be instantiated by hardware logic circuitry, which may be implemented by an ASIC, XPU, or the FPGA circuitry 2300 of FIG. 23 structured to perform operations corresponding to the machine readable instructions. Additionally or alternatively, the image collection circuitry 510 may be instantiated by any other combination of hardware, software, and/or firmware. For example, the image collection circuitry 510 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example calibration datastore 520 of the illustrated example of FIG. 5 stores calibration information including, for example, the location of the position detection circuitry 410, a homograph matrix, prior detected positions of performers, etc. The example calibration datastore 520 of the illustrated example of FIG. 5 is implemented by any memory, storage device and/or storage disc for storing data such as, for example, flash memory, magnetic media, optical media, solid state memory, hard drive(s), thumb drive(s), etc. Furthermore, the data stored in the example calibration datastore 520 may be in any data format such as, for example, binary data, comma delimited data, tab delimited data, structured query language (SQL) structures, etc. While, in the illustrated example, the calibration datastore 520 is illustrated as a single device, the example calibration datastore 520 and/or any other data storage devices described herein may be implemented by any number and/or type(s) of memories.

The example calibration display request circuitry 530 of the illustrated example of FIG. 5 transmits a request to the display controller circuitry 430 requesting display of a calibration pattern. The example display controller 430 causes display of the calibration pattern on the performance area, which can then be captured by the image collection circuitry 510 for use in the calibration process.

In some examples, the calibration display request circuitry 530 is instantiated by processor circuitry executing calibration display request instructions and/or configured to perform operations such as those represented by the flowchart of FIG. 8.

In some examples, the position detection circuitry 500 includes means for requesting. For example, the means for requesting may be implemented by example calibration display request circuitry 530. In some examples, the calibration display request circuitry 530 may be instantiated by processor circuitry such as the example processor circuitry 2112 of FIG. 21. For instance, calibration display request circuitry 530 may be instantiated by the example microprocessor 2200 of FIG. 22 executing machine executable instructions such as those implemented by at least block 830. In some examples, calibration display request circuitry 530 may be instantiated by hardware logic circuitry, which may be implemented by an ASIC, XPU, or the FPGA circuitry 2300 of FIG. 23 structured to perform operations corresponding to the machine readable instructions. Additionally or alternatively, the calibration display request circuitry 530 may be instantiated by any other combination of hardware, software, and/or firmware. For example, the calibration display request circuitry 530 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example homograph matrix generator circuitry 540 of the illustrated example of FIG. 5 generates a homograph matrix that enables translation of a detected position of a point in an image captured by the image capture circuitry 510 to a point in physical space on the performance area 405. (Block 840). In some examples, the homograph matrix generator circuitry 540 is instantiated by processor circuitry executing the homograph matrix generator instructions and/or configured to perform operations such as those represented by the flowchart of FIG. 8.

In some examples, the position detection circuitry 500 includes means for generating. For example, the means for generating may be implemented by example homograph matrix generator circuitry 540. In some examples, the homograph matrix generator circuitry 540 may be instantiated by processor circuitry such as the example processor circuitry 2112 of FIG. 21. For instance, homograph matrix generator circuitry 540 may be instantiated by the example microprocessor 2200 of FIG. 22 executing machine executable instructions such as those implemented by at least blocks 840. In some examples, the homograph matrix generator circuitry 540 may be instantiated by hardware logic circuitry, which may be implemented by an ASIC, XPU, or the FPGA circuitry 2300 of FIG. 23 structured to perform operations corresponding to the machine readable instructions. Additionally or alternatively, the homograph matrix generator circuitry 540 may be instantiated by any other combination of hardware, software, and/or firmware. For example, the homograph matrix generator circuitry 540 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example accuracy tester circuitry 550 of the illustrated example of FIG. 5 tests the translations of the second positions detected using the homograph matrix. The testing is performed by attempting to transform the known positions of performers positioned on the performance area 405 and detecting the accuracy of the transformation(s). If the accuracy tester circuitry 550 determines that the accuracy of the homograph matrix is not sufficient (e.g., the position detection accuracy is not accurate for at least a threshold number of locations (e.g., five locations) within a threshold distance, (e.g., one tenth of a meter)), the homograph matrix generator circuitry 540 further refines the generated homograph matrix. The example process is repeated until the accuracy of the homograph matrix is sufficient, at which point the example image collection circuitry 510 stores the homograph matrix in the calibration datastore 520.

In some examples, the accuracy tester circuitry 550 is instantiated by processor circuitry executing accuracy tester instructions and/or configured to perform operations such as those represented by the flowchart of FIG. 8.

In some examples, the position detection circuitry 500 includes means for testing. For example, the means for testing may be implemented by example accuracy tester circuitry 550. In some examples, the accuracy tester circuitry 550 may be instantiated by processor circuitry such as the example processor circuitry 2112 of FIG. 21. For instance, the accuracy tester circuitry 550 may be instantiated by the example microprocessor 2200 of FIG. 22 executing machine executable instructions such as those implemented by at least blocks 850, 860. In some examples, the accuracy tester circuitry 550 may be instantiated by hardware logic circuitry, which may be implemented by an ASIC, XPU, or the FPGA circuitry 2300 of FIG. 23 structured to perform operations corresponding to the machine readable instructions. Additionally or alternatively, the accuracy tester circuitry 550 0 may be instantiated by any other combination of hardware, software, and/or firmware. For example, the accuracy tester circuitry 550 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example person detector circuitry 560 of the illustrated example of FIG. 5 detects one or more performers in the captured image. In examples disclosed herein, a trained artificial intelligence model is executed by the person detector circuitry 560 to detect a performer. In examples disclosed herein, the AI model was trained using You Only Look Once X (YOLOX). However, other person or object detection approaches may additionally or alternatively be used. In examples disclosed herein, images were captured, annotated, and used for training of the AI model. In some examples, convolutional neural network (CNN) training approaches like data augmentation and hyperparameter tuning were used to achieve high detection rate while avoiding the overfitting on the training dataset. In some examples, modifications were made to the AI model including, for example, pruning of some feature layers, replacing base convolutional layers with depth-wise separate layers, converting the trained float32 Pytorch model into an optimized int8 Openvino model, etc. As a result, the person detector circuitry 560, when executing the model, takes about 12 ms for the person detection process including camera image cropping and resizing, model inference, and post-processing of candidates selection. As an output of the person detection process performed by the person detector circuitry 560, bounding boxes are created for each detected performer.

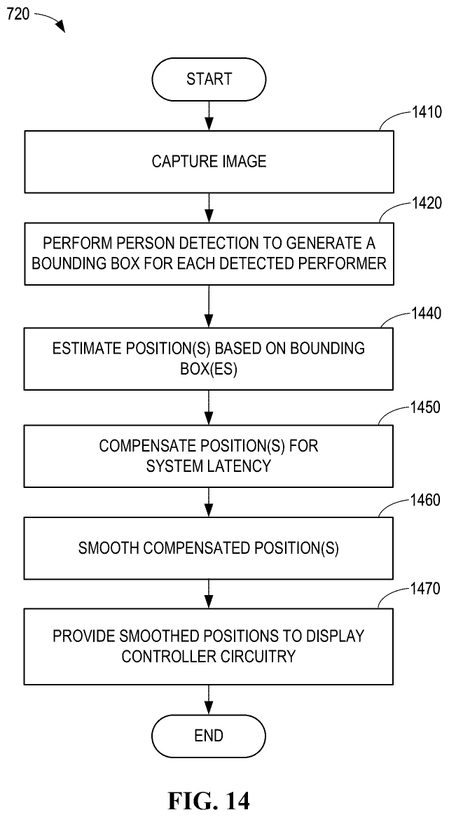

In some examples, the person detector circuitry 560 is instantiated by processor circuitry executing person detector instructions and/or configured to perform operations such as those represented by the flowchart of FIG. 14.

In some examples, the position detection circuitry 500 includes means for detecting. For example, the means for detecting may be implemented by example person detector circuitry 560. In some examples, the person detector circuitry 560 may be instantiated by processor circuitry such as the example processor circuitry 2112 of FIG. 21. For instance, the example person detector circuitry 560 may be instantiated by the example microprocessor 2200 of FIG. 22 executing machine executable instructions such as those implemented by at least blocks 1420. In some examples, person detector circuitry 560 may be instantiated by hardware logic circuitry, which may be implemented by an ASIC, XPU, or the FPGA circuitry 2300 of FIG. 23 structured to perform operations corresponding to the machine readable instructions. Additionally or alternatively, the person detector circuitry 560 may be instantiated by any other combination of hardware, software, and/or firmware. For example, the person detector circuitry 560 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example position estimator circuitry 580 of the illustrated example of FIG. 5 estimates a position of a performer based on the bounding box corresponding to the detected performer. To estimate the person's real position on the ground plane, a pixel position in the camera image where the performers foot is touching the ground is identified. If a location where the foot of the performer can be identified, this point can be used as the location of the performer within the image. Alternatively, if the position of the foot of the performer cannot be identified, a point representing the center of the bottom of the bounding box is used as the location of the performer within the image. In practice, the difference between the two possible points is typically low, having an average of smaller than three tenths of a meter, which is generally acceptable in real-world applications. The example position estimator circuitry 580 then utilizes the homograph matrix stored in the calibration datastore 520 to convert the position of the performer in the image to a position in physical space on the performance area 405.

In some examples, the position estimator circuitry 580 is instantiated by processor circuitry executing position estimator instructions and/or configured to perform operations such as those represented by the flowchart of FIG. 14.

In some examples, the position detection circuitry 500 includes means for estimating. For example, the means for estimating may be implemented by example position estimator circuitry 580. In some examples, the position estimator circuitry 580 may be instantiated by processor circuitry such as the example processor circuitry 2112 of FIG. 21. For instance, the position estimator circuitry 580 may be instantiated by the example microprocessor 2200 of FIG. 22 executing machine executable instructions such as those implemented by at least blocks 1440. In some examples, the position estimator circuitry 580 may be instantiated by hardware logic circuitry, which may be implemented by an ASIC, XPU, or the FPGA circuitry 2300 of FIG. 23 structured to perform operations corresponding to the machine readable instructions. Additionally or alternatively, the position estimator circuitry 580 may be instantiated by any other combination of hardware, software, and/or firmware. For example, the position estimator circuitry 580 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example smoothing circuitry 590 of the illustrated example of FIG. 5 smooths the compensated position of the performer. Smoothing of the position of the performer helps reduce jitter in the detected location of the performer. In examples disclosed herein, the smoothing circuitry 590 implements a one euro filter. However any other type of filter may additionally or alternatively be used such as, for example, a low pass filter. In some examples, the smoothing circuitry 590 is instantiated by processor circuitry executing smoothing instructions and/or configured to perform operations such as those represented by the flowchart of FIG. 14.

In some examples, the position detection circuitry 500 includes means for smoothing. For example, the means for smoothing may be implemented by example smoothing circuitry 590. In some examples, the smoothing circuitry 590 may be instantiated by processor circuitry such as the example processor circuitry 2112 of FIG. 21. For instance, the smoothing circuitry 590 may be instantiated by the example microprocessor 2200 of FIG. 22 executing machine executable instructions such as those implemented by at least block 1460. In some examples, the smoothing circuitry 590 may be instantiated by hardware logic circuitry, which may be implemented by an ASIC, XPU, or the FPGA circuitry 2300 of FIG. 23 structured to perform operations corresponding to the machine readable instructions. Additionally or alternatively, the smoothing circuitry 590 may be instantiated by any other combination of hardware, software, and/or firmware. For example, the smoothing circuitry 590 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example position provider circuitry 595 of the illustrated example of FIG. 5 provides the smoothed position to the display controller circuitry 430. In some examples, the position provider circuitry 595 is instantiated by processor circuitry executing position provider instructions and/or configured to perform operations such as those represented by the flowchart of FIG. 14.

In some examples, the position detection circuitry 500 includes means for providing. For example, the means for providing may be implemented by example position provider circuitry 595. In some examples, the position provider circuitry 595 may be instantiated by processor circuitry such as the example processor circuitry 2112 of FIG. 21. For instance, the position provider circuitry 595 may be instantiated by the example microprocessor 2200 of FIG. 22 executing machine executable instructions such as those implemented by at least block 1470. In some examples, the position provider circuitry 595 may be instantiated by hardware logic circuitry, which may be implemented by an ASIC, XPU, or the FPGA circuitry 2300 of FIG. 23 structured to perform operations corresponding to the machine readable instructions. Additionally or alternatively, the position provider circuitry 595 may be instantiated by any other combination of hardware, software, and/or firmware. For example, the position provider circuitry 595 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the position detection circuitry 500 is illustrated in FIG. 5, one or more of the elements, processes, and/or devices illustrated in FIG. 5 may be combined, divided, re-arranged, omitted, eliminated, and/or implemented in any other way. Further, the example image collection circuitry 510, the example calibration display request circuitry 530, the example homograph matrix generator circuitry 540, the example accuracy tester circuitry 550, the example person detector circuitry 560, the example position estimator circuitry 580, the example smoothing circuitry 590, the example position provider circuitry 595, and/or, more generally, the example position detection circuitry 500 of FIG. 5, may be implemented by hardware alone or by hardware in combination with software and/or firmware. Thus, for example, any of example image collection circuitry 510, the example calibration display request circuitry 530, the example homograph matrix generator circuitry 540, the example accuracy tester circuitry 550, the example person detector circuitry 560, the example position estimator circuitry 580, the example smoothing circuitry 590, the example position provider circuitry 595, and/or, more generally, the example position detection circuitry 500 of FIG. 5, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example position detection circuitry 500 may include one or more elements, processes, and/or devices in addition to, or instead of, those illustrated in FIG. 5, and/or may include more than one of any or all of the illustrated elements, processes and devices.

FIG. 6 is a block diagram representing an example implementation of the example display controller circuitry 430 of FIG. 4. The display controller circuitry 430 of FIG. 6 may be instantiated (e.g., creating an instance of, bring into being for any length of time, materialize, implement, etc.) by processor circuitry such as a central processing unit executing instructions. Additionally or alternatively, the display controller circuitry 430 of FIG. 6 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 6 may, thus, be instantiated at the same or different times. Some or all of the circuitry may be instantiated, for example, in one or more threads executing concurrently on hardware and/or in series on hardware. Moreover, in some examples, some or all of the circuitry of FIG. 6 may be implemented by microprocessor circuitry executing instructions to implement one or more virtual machines and/or containers. The example display controller circuitry 430 of the illustrated example of FIG. 6 includes position receiver circuitry 610, aggregation circuitry 620, redundancy checker circuitry 630, effect generation circuitry 640, and effect outputter circuitry 650.

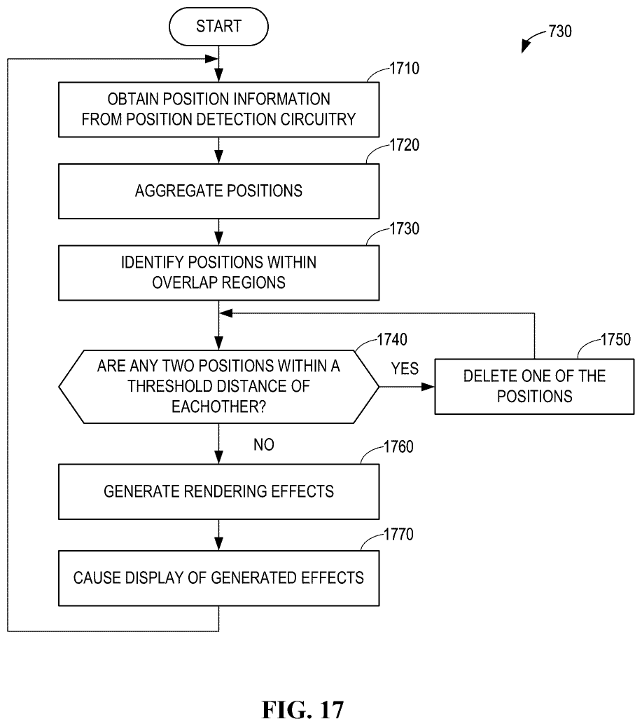

The example position receiver circuitry 610 of the illustrated example of FIG. 6 obtains position information from the position detection circuitries. In some examples, the position information is received via a network, such as a local area network. However, the position information may be received via any other communication technique(s). In some examples, the position receiver circuitry 610 is instantiated by processor circuitry executing position receiver instructions and/or configured to perform operations such as those represented by the flowchart of FIG. 17.

In some examples, the display controller circuitry 430 includes means for accessing. For example, the means for accessing may be implemented by the example position receiver circuitry 610. In some examples, the position receiver circuitry 610 may be instantiated by processor circuitry such as the example processor circuitry 2112 of FIG. 21. For instance, the position receiver circuitry 610 may be instantiated by the example microprocessor 2200 of FIG. 22 executing machine executable instructions such as those implemented by at least block 1710. In some examples, the position receiver circuitry 610 may be instantiated by hardware logic circuitry, which may be implemented by an ASIC, XPU, or the FPGA circuitry 2300 of FIG. 23 structured to perform operations corresponding to the machine readable instructions. Additionally or alternatively, the position receiver circuitry 610 may be instantiated by any other combination of hardware, software, and/or firmware. For example, the position receiver circuitry 610 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example aggregation circuitry 620 of the illustrated example of FIG. 6 aggregates the position information received from the various position detection circuitries (received via the position receiver circuitry 610). In some examples, the aggregation circuitry 620 is instantiated by processor circuitry executing aggregation instructions and/or configured to perform operations such as those represented by the flowchart of FIG. 17.

In some examples, the display controller circuitry 430 includes means for aggregating. For example, the means for aggregating may be implemented by aggregation circuitry 620. In some examples, the aggregation circuitry 620 may be instantiated by processor circuitry such as the example processor circuitry 2112 of FIG. 21. For instance, the aggregation circuitry 620 may be instantiated by the example microprocessor 2200 of FIG. 22 executing machine executable instructions such as those implemented by at least block 1720. In some examples, the aggregation circuitry 620 may be instantiated by hardware logic circuitry, which may be implemented by an ASIC, XPU, or the FPGA circuitry 2300 of FIG. 23 structured to perform operations corresponding to the machine readable instructions. Additionally or alternatively, the aggregation circuitry 620 may be instantiated by any other combination of hardware, software, and/or firmware. For example, the aggregation circuitry 620 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example redundancy checker circuitry 630 of the illustrated example of FIG. 6 identifies positions within overlap region(s) of the aggregated position information to eliminate any redundantly identified performers. When one performer is standing in the physical space represented by the overlap region, there maybe two detection results for the same performer. In examples disclosed herein, four position detection circuitries are used to identify performers in its own corresponding ROI. The example redundancy checker circuitry 630 enables performance of a redundancy check to, for example, identify whether two positions have been identified for the same performer.

If, for example, a performer was identified by two position detection circuitries responsible for adjacent zones of the performance area, one of the position identifications should be omitted to avoid multiple interactive elements being displayed for the performer and/or other rendering irregularities. The example redundancy checker circuitry 630 determines whether any two positions are within a threshold distance of each other. In examples disclosed herein, the threshold distance is three tenths of a meter. If two positions are detected within the threshold distance of each other, one of the positions Is removed by the redundancy checker circuitry 630. That is, the two identifications for the same performer are reduced to a single identification for the single performer. In some examples, positions from one of the position detection circuitries are preferred over the other. That is, when two positions are detected within the threshold distance of each other, the position that originated from a first one of the position detection circuitries is kept, while the position that originated from a second one of the position detection circuitries is deleted.

In some examples, the redundancy checker circuitry 630 is instantiated by processor circuitry executing redundancy checker instructions and/or configured to perform operations such as those represented by the flowchart of FIG. 17.

In some examples, the display controller circuitry 430 includes means for checking. For example, the means for checking may be implemented by redundancy checker circuitry 630. In some examples, the redundancy checker circuitry 630 may be instantiated by processor circuitry such as the example processor circuitry 2112 of FIG. 21. For instance, the redundancy checker circuitry 630 may be instantiated by the example microprocessor 2200 of FIG. 22 executing machine executable instructions such as those implemented by at least blocks 1730, 1740, 1750. In some examples, the redundancy checker circuitry 630 may be instantiated by hardware logic circuitry, which may be implemented by an ASIC, XPU, or the FPGA circuitry 2300 of FIG. 23 structured to perform operations corresponding to the machine readable instructions. Additionally or alternatively, the redundancy checker circuitry 630 may be instantiated by any other combination of hardware, software, and/or firmware. For example, the redundancy checker circuitry 630 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example effect generation circuitry 640 of the illustrated example of FIG. 6 generates rendering effects based on the detected positions of the performers. In some examples, the effects are generated using a rendering engine such as, for example, Unity or Unreal. However, any other rendering engine and/or techniques for generating interactive effects may additionally or alternatively be used. In some examples, the effect generation circuitry 640 is instantiated by processor circuitry executing effect generation instructions and/or configured to perform operations such as those represented by the flowchart of FIG. 17.

In some examples, the display controller circuitry 430 includes means for creating. For example, the means for creating may be implemented by effect generation circuitry 640. In some examples, the effect generation circuitry 640 may be instantiated by processor circuitry such as the example processor circuitry 2112 of FIG. 21. For instance, the effect generation circuitry 640 may be instantiated by the example microprocessor 2200 of FIG. 22 executing machine executable instructions such as those implemented by at least blocks 1760. In some examples, the effect generation circuitry 640 may be instantiated by hardware logic circuitry, which may be implemented by an ASIC, XPU, or the FPGA circuitry 2300 of FIG. 23 structured to perform operations corresponding to the machine readable instructions. Additionally or alternatively, the effect generation circuitry 640 may be instantiated by any other combination of hardware, software, and/or firmware. For example, the effect generation circuitry 640 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example effect outputter circuitry 650 of the illustrated example of FIG. 6 causes display of the generated effect(s). In some examples, the effect outputter circuitry 650 is implemented by a display driver. However, any other approach to implementing the effect outputter circuitry 650 may additionally or alternatively be used.

In some examples, the effect outputter circuitry 650 is instantiated by processor circuitry executing effect outputter instructions and/or configured to perform operations such as those represented by the flowchart of FIG. 17.

In some examples, the display controller circuitry 430 includes means for outputting. For example, the means for outputting may be implemented by effect outputter circuitry 650. In some examples, the effect outputter circuitry 650 may be instantiated by processor circuitry such as the example processor circuitry 2112 of FIG. 21. For instance, the effect outputter circuitry 650 may be instantiated by the example microprocessor 2200 of FIG. 22 executing machine executable instructions such as those implemented by at least block 1760. In some examples, the effect outputter circuitry 650 may be instantiated by hardware logic circuitry, which may be implemented by an ASIC, XPU, or the FPGA circuitry 2300 of FIG. 23 structured to perform operations corresponding to the machine readable instructions. Additionally or alternatively, the effect outputter circuitry 650 may be instantiated by any other combination of hardware, software, and/or firmware. For example, the effect outputter circuitry 650 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the display controller circuitry 430 is illustrated in FIG. 6, one or more of the elements, processes, and/or devices illustrated in FIG. 6 may be combined, divided, re-arranged, omitted, eliminated, and/or implemented in any other way. Further, the example position receiver circuitry 610, the example aggregation circuitry 620, the example redundancy checker circuitry 630, the example effect generation circuitry 640, the example effect outputter circuitry 650, and/or, more generally, the example display controller circuitry 430 of FIG. 6, may be implemented by hardware alone or by hardware in combination with software and/or firmware. Thus, for example, any of the example position receiver circuitry 610, the example aggregation circuitry 620, the example redundancy checker circuitry 630, the example effect generation circuitry 640, the example effect outputter circuitry 650, and/or, more generally, the example display controller circuitry 430 of FIG. 6, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example display controller circuitry 430 of FIG. 6 may include one or more elements, processes, and/or devices in addition to, or instead of, those illustrated in FIG. 6, and/or may include more than one of any or all of the illustrated elements, processes and devices.

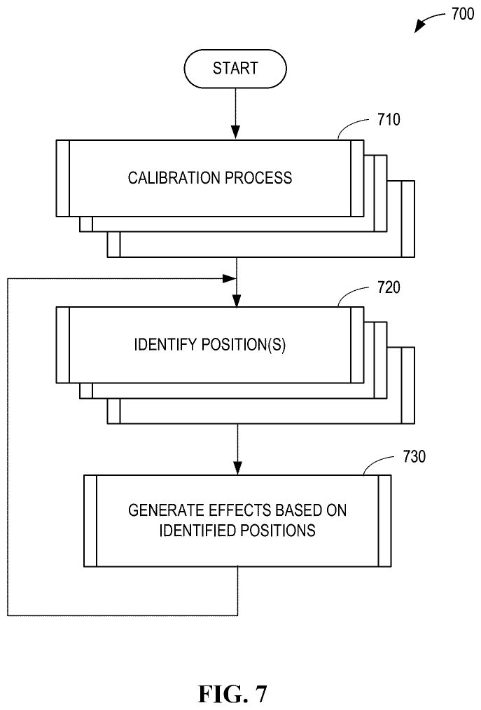

Flowcharts representative of example machine readable instructions, which may be executed to configure processor circuitry to implement the position detection circuitry 410 and/or the display controller circuitry 430 of FIG. 4, is shown in FIGS. 7, 8, 15, and 17. The machine readable instructions may be one or more executable programs or portion(s) of an executable program for execution by processor circuitry, such as the processor circuitry 2112 shown in the example processor platform 2100 discussed below in connection with FIG. 21 and/or the example processor circuitry discussed below in connection with FIGS. 22 and/or 23. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 7, 8, 15, and 17, many other methods of implementing the example position detection circuitry 410 and/or the example display controller circuitry 430 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 7, 8, 14, and/or 17 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 7 is a flowchart representative of example machine readable instructions and/or example operations that may be executed by example processor circuitry to implement the interactive presentation system 407 of FIG. 4 to create an interactive performance. The machine readable instructions and/or the operations 700 of FIG. 7 begin at block 710, at which each position detection circuitry 500 performs a calibration process. (Block 710). In the illustrated example of FIG. 7, the calibration process is performed once during, for example, setup of the interactive presentation system 407. However, in some examples, the calibration process may be re-performed periodically (e.g., daily) and/or a-periodically (e.g., prior to a performance event). Calibration of the position detection circuitry 500 ensures that the position detection circuitry 500 accurately provides information to the display controller 430 regarding positions of the performers. In the illustrated example of FIG. 7, the multiple iterations of block 710 represent the calibration process being performed for each position detection circuitry 500. In some examples, the calibration process is performed serially for each of the position detection circuitries. However, it may be equally useful to perform such calibration in parallel. Further details of the calibration process are provided in connection with FIG. 8, below.

After calibration, the example position detection circuitry 500 detects positions of performers, and reports the position(s) to the display controller circuitry 430. (Block 720). Such detection of performers is based on the calibration process performed at block 710. In the illustrated example of FIG. 7, the multiple iterations of block 720 represent the position identification process being performed for each position detection circuitry 500. While the calibration process can be performed serially for each of the position detection circuitries, the position identification process is ideally performed in parallel by each of the position detection circuitries. Further details of the position detection process are provided in connection with FIG. 14, below.

The example display controller circuitry 430 receives the position information from each of the position detection circuitries and generates one or more effects based on the identified positions. (Block 730). In some examples, display controller circuitry 430 aggregates the position information from each of the position detection circuitries to create an understanding of the location(s) of each of the performers in the performance area 405. Further details of the effect generation process are provided in connection with FIG. 17, below. The process of blocks 720 and 730 are then repeated to continue the interactive performance. Such process may be terminated upon, for example, request by a user (e.g., a director of the performance), and/or a defined ending of the performance.

FIG. 8 is a flowchart representative of example machine readable instructions and/or example operations that may be executed by example processor circuitry to implement the position detection circuitry of FIG. 4 to calibrate the position detection circuitry. The machine readable instructions and/or the operations 710 of FIG. 8 begin at block 810, where the image collection circuitry 510 identifies a position of the camera with respect to the performance area. (Block 810).

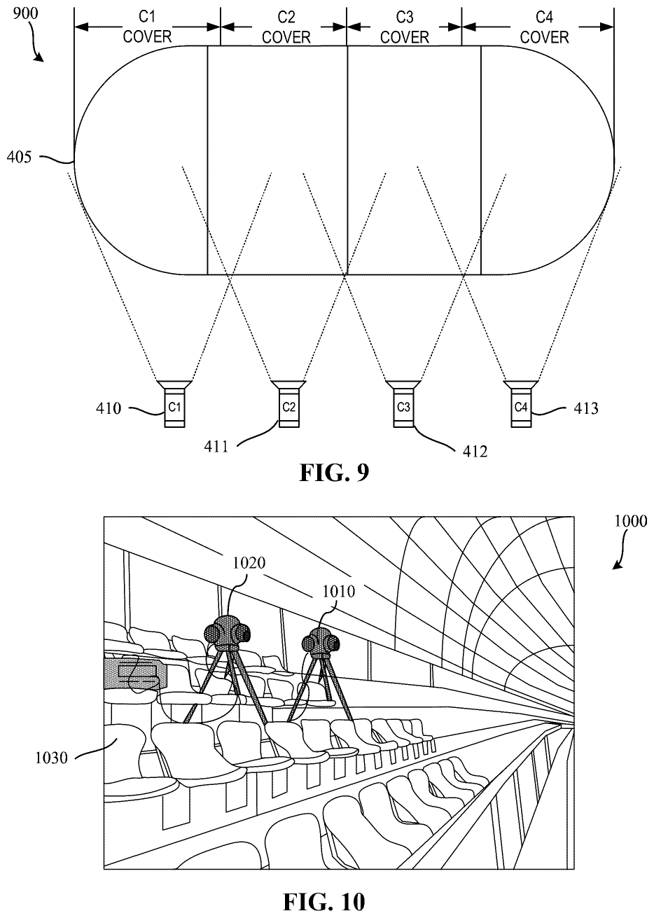

FIG. 9 is a plan view representation 900 of the example system of FIG. 4. In the illustrated example of FIG. 9, each position detection circuitry 410, 411, 412, 413 covers a corresponding zone. The position of the position detection circuitry 410 is known (e.g., fixed), as illustrated in FIG. 10, which depicts positioning of the example position detection circuitry of FIGS. 4 and/or 5. For example, the position of the position detection circuitry 1010 of FIG. 10 (corresponding to the position detection circuitry 410) is known in relation to a point on the stage (e.g., a center point of the stage). In the illustrated example of FIG. 10, a secondary position detection circuitry 1020 is shown. In some examples, the secondary position detection circuitry 1020 uses the same position as the position detection circuitry 1010. In the illustrated example of FIG. 10, the position detection circuitries 1010, 1020 are positioned in an upper area 1030 of an arena surrounding the performance area 405. Such positioning ensures a clear vantage point of the zone of the performance area for which the position detection circuitries 1010, 1020 are to detect performer locations.

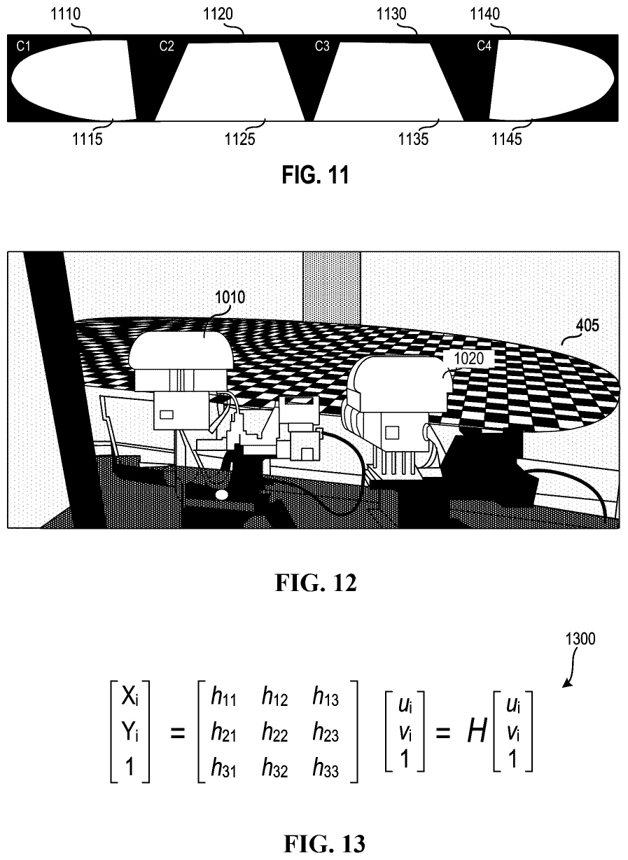

Returning to FIG. 8, the example image collection circuitry 510 then identifies a region of interest in an image of the performance area. (Block 820). FIG. 11 is an illustration of a region of interest (ROI) mask. In the illustrated example of FIG. 11, four sections 1110, 1120, 1130, 1140 are shown, each corresponding to respective person detection circuitry 500. In examples disclosed herein, each position detection circuitry 500 uses its own region of interest (ROI) mask 1115, 1125, 1135, 1145, which identifies an area of the captured image where performers may be recognized. In examples disclosed herein, the ROI mask is manually defined. However, in some examples, the ROI may be automatically detected from the captured image(s) Any performers outside of the ROI mask regions will be not detected. Images captured by the image collection circuitry 510 are cropped using the ROI mask, resized to an appropriate input size (e.g., 1280×960), and are then used by the person detector circuitry 560 during operation to detect a location of a performer.

Returning to FIG. 8, the example calibration display request circuitry 530 then transmits a request to the display controller circuitry 430 requesting display of a calibration pattern. (Block 830). The example display controller 430 causes display of the calibration pattern on the performance area, which can then be captured by the image collection circuitry 510. FIG. 12 illustrates an example vantage point of the example position detection circuitry of FIGS. 4 and/or 5 with respect to a stage. In the illustrated example of FIG. 12, a calibration pattern (e.g., a checkerboard pattern) is displayed in the performance area. However, any other calibration pattern may additionally or alternatively be used including, for example, a grid pattern.

A captured image of the calibration pattern is used by the homograph matrix generator circuitry 540 to generate a homograph matrix. (Block 840). FIG. 13 is a representation of a homograph matrix 1300. To track the real-world position of a performer on the stage, the homograph estimation method is used to compute the transformation between the camera imaging plane and the stage plane. The homograph matrix H illustrated in FIG. 13 is estimated by finding a mapping from the image pixels (uᵢ, vᵢ) to the ground screen positions (Xᵢ, Yᵢ).

To estimate the matrix H, the calibration pattern displayed in response to the request of block 830 is captured. In examples disclosed herein, the calibration pattern has a known grid size on the performance area. A first number (e.g., four) points are marked on the image, and are used to generate a 3×3 homograph matrix by finding a mapping from the pixel points to the ground points. A second number of positions on the performance area are also selected, and are used for testing the accuracy of the homograph matrix.

The example accuracy tester circuitry 550 then tests the translations of the second positions detected using the homograph matrix. (Block 850). If the accuracy tester circuitry 550 determines that the accuracy of the homograph matrix is not sufficient (Block 860 returns a result of NO) (e.g., the position detection accuracy is not accurate for at least a threshold number of locations (e.g., five locations) within a threshold distance, (e.g., one tenth of a meter)), the example process returns to block 840 where the homograph matrix generator circuitry 540 further refines the generated homograph matrix. The example process of blocks 840-860 is repeated until the accuracy of the homograph matrix is sufficient, at which point the example image collection circuitry 510 stores the homograph matrix in the calibration datastore 520. (Block 870).

FIG. 14 is a flowchart representative of example machine readable instructions and/or example operations that may be executed by example processor circuitry to implement the position detection circuitry of FIG. 4 to locate a performer. The machine readable instructions and/or the operations 720 of FIG. 14 begin when the example image collection circuitry 510 captures an image via the image sensor 505. (Block 1410). The example person detector circuitry 560 detects one or more performers in the captured image. (Block 1420). In examples disclosed herein, a trained artificial intelligence model is executed by the person detector circuitry 560 to detect a performer. In examples disclosed herein, the AI model was trained using You Only Look Once X (YOLOX). However, other person or object detection approaches may additionally or alternatively be used. In examples disclosed herein, images were captured, annotated, and used for training of the AI model. In some examples, CNN training approaches like data augmentation and hyperparameter tuning were used to achieve high detection rate while avoiding the overfitting on the training dataset. In some examples, modifications were made to the AI model including, for example, pruning of some feature layers, replacing base convolutional layers with depth-wise separate layers, converting the trained float32 Pytorch model into an optimized int8 Openvino model, etc. As a result, the person detector circuitry 560, when executing the model, takes about 12 ms for the person detection process including camera image cropping and resizing, model inference, and post-processing of candidates selection. As an output of the person detection process performed by the person detector circuitry 560, bounding boxes are created for each detected performer.

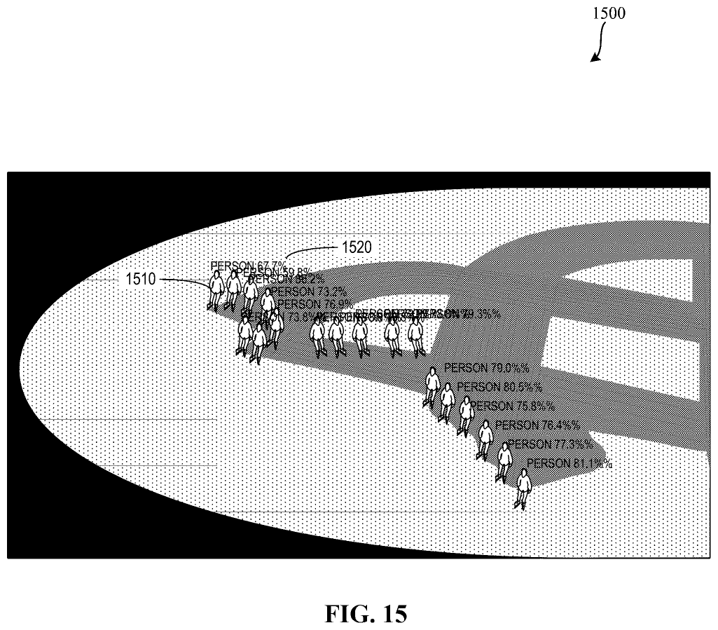

FIG. 15 is a representation 1500 of an interactive performance, including person detection information. In the illustrated example of FIG. 15, bounding boxes are overlaid surrounding each of the performers. For example, bounding box 1510 represents one of the detected performers. In some examples, additional information 1520 is also overlaid related to identification of the performer represented by the bounding box 1510.

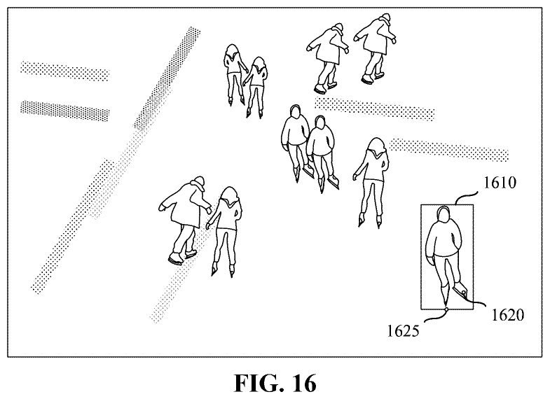

Returning to FIG. 14, the example position estimator circuitry 580 estimates a position of a performer based on the bounding box corresponding to the detected performer. (Block 1440). To estimate the person's real position on the ground plane, a pixel position in the camera image where the performers foot is touching the ground is identified. FIG. 16 is a representation of location detection of a person based on a bounding box position 1610. If a location where the foot of the performer can be identified (e.g., point 1620 in FIG. 16), this point can be used as the location of the performer within the image. Alternatively, if the position of the foot of the performer cannot be identified, a point representing the center of the bottom of the bounding box is used as the location of the performer within the image (e.g., point 1625 in FIG. 16). In practice, the difference between the two possible points is typically low, having an average of smaller than three tenths of a meter, which is generally acceptable in real-world applications. The example position estimator circuitry 580 then utilizes the homograph matrix stored in the calibration datastore 520 to convert the position of the performer in the image to a position in physical space on the performance area 405.

The example position estimator circuitry 580 compensates the position to account for system latency. (Block 1450). For example, whereas position detection might be performed every one hundred milliseconds, if the performer is moving at a high rate of speed, the detected position might lag behind the performer. To account for this, the example position estimator circuitry 580 compensates using prior detected positions of the performer by predicting a new position along the moving direction of the position. In other words, to a small offset is added to the current position. In some examples, this small offset is achieved by the multiplication of the velocity and a short time.

The example smoothing circuitry 590 smooths the compensated position of the performer. (Block 1460). Smoothing of the position of the performer helps reduce jitter in the detected location of the performer.

The example position provider circuitry 595 provides the smoothed position to the display controller circuitry 430. (Block 1470). The example process 720 of FIG. 14 may then be repeated to enable sequential detection of locations of the performers.

FIG. 17 is a flowchart representative of example machine readable instructions and/or example operations that may be executed by example processor circuitry to implement the display controller of FIG. 4 to generate an interactive element based on the location of a performer. The machine readable instructions and/or the operations 730 of FIG. 17 begin at block 1710, at which the position receiver circuitry 610 obtains position information from the position detection circuitries (Block 1710). The example aggregation circuitry 620 aggregates the position information. (Block 1720).

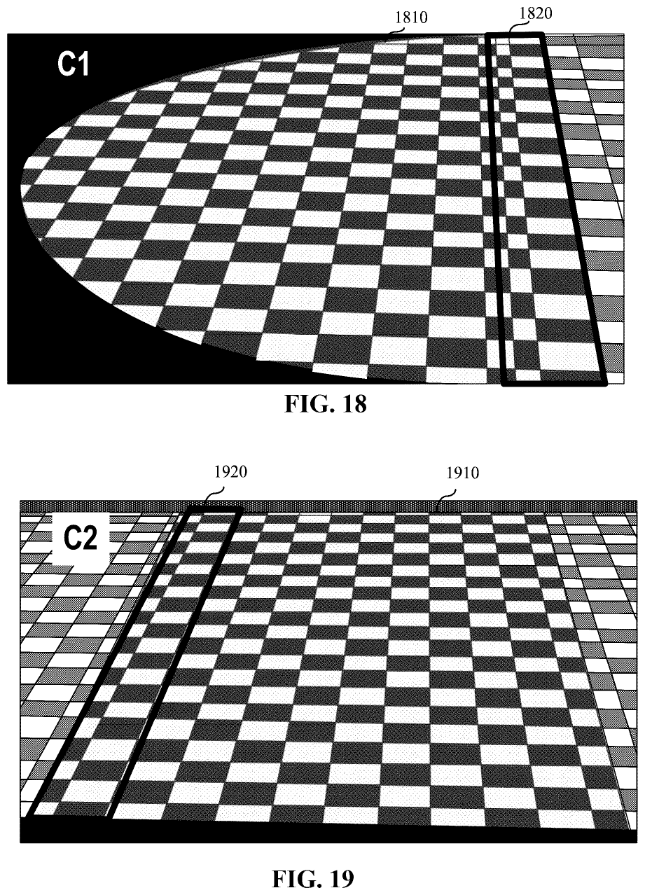

The example redundancy checker circuitry 630 identifies positions within overlap region(s). (Block 1730). FIG. 18 illustrates an example ROI definition 1810 for a first camera, including a first overlap region 1820, while FIG. 19 illustrates an example ROI definition 1910 for a second camera that is adjacent to the first camera of represented in connection with FIG. 18, including a second overlap region 1920. When one performer is standing in the physical space represented by the overlap region, there maybe two detection results for the same performer. In examples disclosed herein, four position detection circuitries are used to identify performers in its own corresponding ROI. The example redundancy checker circuitry 630 enables performance of a redundancy check to, for example, identify whether two positions have been identified for the same performer.

If, for example, a performer was identified by two position detection circuitries responsible for adjacent zones of the performance area, one of the position identifications should be omitted to avoid multiple interactive elements being displayed for the performer and/or other rendering irregularities. The example redundancy checker circuitry 630 determines whether any two positions are within a threshold distance of each other. (Block 1740). In examples disclosed herein, the threshold distance is three tenths of a meter. If two positions are detected within the threshold distance of each other, one of the positions is removed by the redundancy checker circuitry 630. (Block 1750). That is, the two identifications for the same performer are reduced to a single identification for the single performer. In some examples, positions from one of the position detection circuitries are preferred over the other. That is, when two positions are detected within the threshold distance of each other, the position that originated from a first one of the position detection circuitries is kept, while the position that originated from a second one of the position detection circuitries is deleted.

The example effect generation circuitry 640 generates rendering effects based on the detected positions of the performers. (Block 1760). In some examples, the effects are generated using a rendering engine such as, for example, Unity or Unreal. However, any other rendering engine and/or techniques for generating interactive effects may additionally or alternatively be used. The example effect outputter circuitry 650 then causes display of the generated effects. (Block 1770).

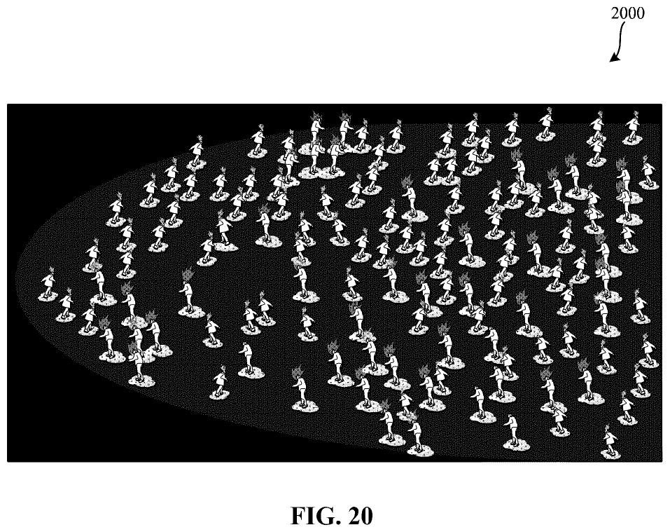

FIG. 20 is an example of an interactive performance 2000, output by the interactive presentation system 407 of FIG. 4.

FIG. 21 is a block diagram of an example processor platform 2100 structured to execute and/or instantiate the machine readable instructions and/or the operations of FIGS. 7, 8, 14, and/or 17 to implement the position detection circuitry 410 and/or display controller circuitry 430 of FIG. 4. The processor platform 2100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 2100 of the illustrated example includes processor circuitry 2112. The processor circuitry 2112 of the illustrated example is hardware. For example, the processor circuitry 2112 can be implemented by one or more integrated circuits, logic circuits, FPGAs, microprocessors, CPUs, GPUs, DSPs, and/or microcontrollers from any desired family or manufacturer. The processor circuitry 2112 may be implemented by one or more semiconductor based (e.g., silicon based) devices. In this example, the processor circuitry 2112 implements the example position detection circuitry 410 and/or the example display controller circuitry 430. In examples disclosed herein, the position detection circuitry 410, 411, 412, 413, as well as the display controller circuitry 430 are implemented by separate processor platforms. However, in some examples, the position detection circuitry 410, 411, 412, 413 and/or the example display controller circuitry 430 may be implemented on a same processor platform. In such an example, the image sensors corresponding to each of the position detector circuitries may provide location information to a central location that includes one or more instances of the position detection circuitry 410, 411, 412, 413. In some examples, the display controller circuitry 430 may be implemented at a same processor platform as one of the position detector circuitries.

The processor circuitry 2112 of the illustrated example includes a local memory 2113 (e.g., a cache, registers, etc.). The processor circuitry 2112 of the illustrated example is in communication with a main memory including a volatile memory 2114 and a non-volatile memory 2116 by a bus 2118. The volatile memory 2114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 2116 may be implemented by flash memory and/or any other desired type of memory device. Access to the main memory 2114, 2116 of the illustrated example is controlled by a memory controller 2117.

The processor platform 2100 of the illustrated example also includes interface circuitry 2120. The interface circuitry 2120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 2122 are connected to the interface circuitry 2120. The input device(s) 2122 permit(s) a user to enter data and/or commands into the processor circuitry 2112. The input device(s) 2122 can be implemented by, for example, an audio sensor, a microphone, a camera (still or video), a keyboard, a button, a mouse, a touchscreen, a track-pad, a trackball, an isopoint device, and/or a voice recognition system.

One or more output devices 2124 are also connected to the interface circuitry 2120 of the illustrated example. The output device(s) 2124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 2120 of the illustrated example, thus, typically includes a graphics driver card, a graphics driver chip, and/or graphics processor circuitry such as a GPU.

The interface circuitry 2120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 2126. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 2100 of the illustrated example also includes one or more mass storage devices 2128 to store software and/or data. Examples of such mass storage devices 2128 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 2132, which may be implemented by the machine readable instructions of FIGS. 7, 8, 14, and/or 17, may be stored in the mass storage device 2128, in the volatile memory 2114, in the non-volatile memory 2116, and/or on a removable non-transitory computer readable storage medium such as a CD or DVD.

FIG. 22 is a block diagram of an example implementation of the processor circuitry 2112 of FIG. 21. In this example, the processor circuitry 2112 of FIG. 21 is implemented by a microprocessor 2200. For example, the microprocessor 2200 may be a general purpose microprocessor (e.g., general purpose microprocessor circuitry). The microprocessor 2200 executes some or all of the machine readable instructions of the flowcharts of FIGS. 7, 8, 14, and/or 17 to effectively instantiate the position detection circuitry 410 and/or display controller circuitry 430 of FIGS. 4, 5, and/or 6 as logic circuits to perform the operations corresponding to those machine readable instructions. In some such examples, the position detection circuitry 410 and/or display controller circuitry 430 of FIGS. 4, 5, and/or 6 is instantiated by the hardware circuits of the microprocessor 2200 in combination with the instructions. For example, the microprocessor 2200 may be implemented by multi-core hardware circuitry such as a CPU, a DSP, a GPU, an XPU, etc. Although it may include any number of example cores 2202 (e.g., 1 core), the microprocessor 2200 of this example is a multi-core semiconductor device including N cores. The cores 2202 of the microprocessor 2200 may operate independently or may cooperate to execute machine readable instructions. For example, machine code corresponding to a firmware program, an embedded software program, or a software program may be executed by one of the cores 2202 or may be executed by multiple ones of the cores 2202 at the same or different times. In some examples, the machine code corresponding to the firmware program, the embedded software program, or the software program is split into threads and executed in parallel by two or more of the cores 2202. The software program may correspond to a portion or all of the machine readable instructions and/or operations represented by the flowcharts of FIG. 7, 8, 14, 17.

The cores 2202 may communicate by a first example bus 2204. In some examples, the first bus 2204 may be implemented by a communication bus to effectuate communication associated with one(s) of the cores 2202. For example, the first bus 2204 may be implemented by at least one of an Inter-Integrated Circuit (I2C) bus, a Serial Peripheral Interface (SPI) bus, a PCI bus, or a PCIe bus. Additionally or alternatively, the first bus 2204 may be implemented by any other type of computing or electrical bus. The cores 2202 may obtain data, instructions, and/or signals from one or more external devices by example interface circuitry 2206. The cores 2202 may output data, instructions, and/or signals to the one or more external devices by the interface circuitry 2206. Although the cores 2202 of this example include example local memory 2220 (e.g., Level 1 (L1) cache that may be split into an L1 data cache and an L1 instruction cache), the microprocessor 2200 also includes example shared memory 2210 that may be shared by the cores (e.g., Level 2 (L2 cache)) for high-speed access to data and/or instructions. Data and/or instructions may be transferred (e.g., shared) by writing to and/or reading from the shared memory 2210. The local memory 2220 of each of the cores 2202 and the shared memory 2210 may be part of a hierarchy of storage devices including multiple levels of cache memory and the main memory (e.g., the main memory 2114, 2116 of FIG. 21). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 2202 may be referred to as a CPU, DSP, GPU, etc., or any other type of hardware circuitry. Each core 2202 includes control unit circuitry 2214, arithmetic and logic (AL) circuitry (sometimes referred to as an ALU) 2216, a plurality of registers 2218, the local memory 2220, and a second example bus 2222. Other structures may be present. For example, each core 2202 may include vector unit circuitry, single instruction multiple data (SIMD) unit circuitry, load/store unit (LSU) circuitry, branch/jump unit circuitry, floating-point unit (FPU) circuitry, etc. The control unit circuitry 2214 includes semiconductor-based circuits structured to control (e.g., coordinate) data movement within the corresponding core 2202. The AL circuitry 2216 includes semiconductor-based circuits structured to perform one or more mathematic and/or logic operations on the data within the corresponding core 2202. The AL circuitry 2216 of some examples performs integer based operations. In other examples, the AL circuitry 2216 also performs floating point operations. In yet other examples, the AL circuitry 2216 may include first AL circuitry that performs integer based operations and second AL circuitry that performs floating point operations. In some examples, the AL circuitry 2216 may be referred to as an Arithmetic Logic Unit (ALU). The registers 2218 are semiconductor-based structures to store data and/or instructions such as results of one or more of the operations performed by the AL circuitry 2216 of the corresponding core 2202. For example, the registers 2218 may include vector register(s), SIMD register(s), general purpose register(s), flag register(s), segment register(s), machine specific register(s), instruction pointer register(s), control register(s), debug register(s), memory management register(s), machine check register(s), etc. The registers 2218 may be arranged in a bank as shown in FIG. 22. Alternatively, the registers 2218 may be organized in any other arrangement, format, or structure including distributed throughout the core 2202 to shorten access time. The second bus 2222 may be implemented by at least one of an I2C bus, a SPI bus, a PCI bus, or a PCIe bus

Each core 2202 and/or, more generally, the microprocessor 2200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 2200 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 23 is a block diagram of another example implementation of the processor circuitry 2112 of FIG. 21. In this example, the processor circuitry 2112 is implemented by FPGA circuitry 2300. For example, the FPGA circuitry 2300 may be implemented by an FPGA. The FPGA circuitry 2300 can be used, for example, to perform operations that could otherwise be performed by the example microprocessor 2200 of FIG. 22 executing corresponding machine readable instructions. However, once configured, the FPGA circuitry 2300 instantiates the machine readable instructions in hardware and, thus, can often execute the operations faster than they could be performed by a general purpose microprocessor executing the corresponding software.

More specifically, in contrast to the microprocessor 2200 of FIG. 22 described above (which is a general purpose device that may be programmed to execute some or all of the machine readable instructions represented by the flowcharts of FIGS. 7, 8, 14, and/or 17 but whose interconnections and logic circuitry are fixed once fabricated), the FPGA circuitry 2300 of the example of FIG. 23 includes interconnections and logic circuitry that may be configured and/or interconnected in different ways after fabrication to instantiate, for example, some or all of the machine readable instructions represented by the flowcharts of FIGS. 7, 8, 14, and/or 17. In particular, the FPGA circuitry 2300 may be thought of as an array of logic gates, interconnections, and switches. The switches can be programmed to change how the logic gates are interconnected by the interconnections, effectively forming one or more dedicated logic circuits (unless and until the FPGA circuitry 2300 is reprogrammed). The configured logic circuits enable the logic gates to cooperate in different ways to perform different operations on data received by input circuitry. Those operations may correspond to some or all of the software represented by the flowcharts of FIGS. 7, 8, 14, and/or 17. As such, the FPGA circuitry 2300 may be structured to effectively instantiate some or all of the machine readable instructions of the flowcharts of FIGS. 7, 8, 14, and/or 17 as dedicated logic circuits to perform the operations corresponding to those software instructions in a dedicated manner analogous to an ASIC. Therefore, the FPGA circuitry 2300 may perform the operations corresponding to the some or all of the machine readable instructions of FIG. 21 faster than the general purpose microprocessor can execute the same.

In the example of FIG. 23, the FPGA circuitry 2300 is structured to be programmed (and/or reprogrammed one or more times) by an end user by a hardware description language (HDL) such as Verilog. The FPGA circuitry 2300 of FIG. 23, includes example input/output (I/O) circuitry 2302 to obtain and/or output data to/from example configuration circuitry 2304 and/or external hardware 2306. For example, the configuration circuitry 2304 may be implemented by interface circuitry that may obtain machine readable instructions to configure the FPGA circuitry 2300, or portion(s) thereof. In some such examples, the configuration circuitry 2304 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 2306 may be implemented by external hardware circuitry. For example, the external hardware 2306 may be implemented by the microprocessor 2200 of FIG. 22. The FPGA circuitry 2300 also includes an array of example logic gate circuitry 2308, a plurality of example configurable interconnections 2310, and example storage circuitry 2312. The logic gate circuitry 2308 and the configurable interconnections 2310 are configurable to instantiate one or more operations that may correspond to at least some of the machine readable instructions of FIG. and/or other desired operations. The logic gate circuitry 2308 shown in FIG. 23 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 2308 to enable configuration of the electrical structures and/or the logic gates to form circuits to perform desired operations. The logic gate circuitry 2308 may include other electrical structures such as look-up tables (LUTs), registers (e.g., flip-flops or latches), multiplexers, etc.

The configurable interconnections 2310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 2308 to program desired logic circuits.

The storage circuitry 2312 of the illustrated example is structured to store result(s) of the one or more of the operations performed by corresponding logic gates. The storage circuitry 2312 may be implemented by registers or the like. In the illustrated example, the storage circuitry 2312 is distributed amongst the logic gate circuitry 2308 to facilitate access and increase execution speed.

The example FPGA circuitry 2300 of FIG. 23 also includes example Dedicated Operations Circuitry 2314. In this example, the Dedicated Operations Circuitry 2314 includes special purpose circuitry 2316 that may be invoked to implement commonly used functions to avoid the need to program those functions in the field. Examples of such special purpose circuitry 2316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 2300 may also include example general purpose programmable circuitry 2318 such as an example CPU 2320 and/or an example DSP 2322. Other general purpose programmable circuitry 2318 may additionally or alternatively be present such as a GPU, an XPU, etc., that can be programmed to perform other operations.

Although FIGS. 22 and 23 illustrate two example implementations of the processor circuitry 2112 of FIG. 21, many other approaches are contemplated. For example, as mentioned above, modern FPGA circuitry may include an on-board CPU, such as one or more of the example CPU 2320 of FIG. 23. Therefore, the processor circuitry 2112 of FIG. 21 may additionally be implemented by combining the example microprocessor 2200 of FIG. 22 and the example FPGA circuitry 2300 of FIG. 23. In some such hybrid examples, a first portion of the machine readable instructions represented by the flowcharts of FIGS. 7, 8, 14, and/or 17 may be executed by one or more of the cores 2202 of FIG. 22, a second portion of the machine readable instructions represented by the flowcharts of FIGS. 7, 8, 14, and/or 17 may be executed by the FPGA circuitry 2300 of FIG. 23, and/or a third portion of the machine readable instructions represented by the flowchart of FIGS. 7, 8, 14, and/or 17 may be executed by an ASIC. It should be understood that some or all of the circuitry of FIG. 23 may, thus, be instantiated at the same or different times. Some or all of the circuitry may be instantiated, for example, in one or more threads executing concurrently and/or in series. Moreover, in some examples, some or all of the circuitry of FIG. 23 may be implemented within one or more virtual machines and/or containers executing on the microprocessor.

In some examples, the processor circuitry 2112 of FIG. 21 may be in one or more packages. For example, the microprocessor 2200 of FIG. 22 and/or the FPGA circuitry 2300 of FIG. 23 may be in one or more packages. In some examples, an XPU may be implemented by the processor circuitry 2112 of FIG. 21, which may be in one or more packages. For example, the XPU may include a CPU in one package, a DSP in another package, a GPU in yet another package, and an FPGA in still yet another package.

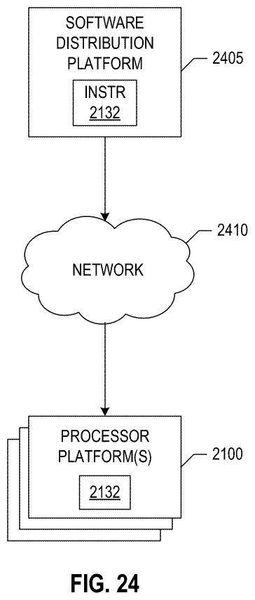

A block diagram illustrating an example software distribution platform 2405 to distribute software such as the example machine readable instructions 2132 of FIG. 21 to hardware devices owned and/or operated by third parties is illustrated in FIG. 24. The example software distribution platform 2405 may be implemented by any computer server, data facility, cloud service, etc., capable of storing and transmitting software to other computing devices. The third parties may be customers of the entity owning and/or operating the software distribution platform 2405. For example, the entity that owns and/or operates the software distribution platform 2405 may be a developer, a seller, and/or a licensor of software such as the example machine readable instructions 2132 of FIG. 21. The third parties may be consumers, users, retailers, OEMs, etc., who purchase and/or license the software for use and/or re-sale and/or sub-licensing. In the illustrated example, the software distribution platform 2405 includes one or more servers and one or more storage devices. The storage devices store the machine readable instructions 2132, which may correspond to the example machine readable instructions of FIGS. 7, 8, 14, and/or 17, as described above. The one or more servers of the example software distribution platform 2405 are in communication with an example network 2410, which may correspond to any one or more of the Internet and/or any of the example networks 2126 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 2132 from the software distribution platform 2405. For example, the software, which may correspond to the example machine readable instructions of FIGS. 7, 8, 14, and/or 17, may be downloaded to the example processor platform 2100, which is to execute the machine readable instructions 2132 to implement the position detection circuitry 410 and/or the display controller circuitry 430. In some examples, one or more servers of the software distribution platform 2405 periodically offer, transmit, and/or force updates to the software (e.g., the example machine readable instructions 2132 of FIG. 21) to ensure improvements, patches, updates, etc., are distributed and applied to the software at the end user devices.

From the foregoing, it will be appreciated that example systems, methods, apparatus, and articles of manufacture have been disclosed that enable large scale interactive performances. Disclosed systems, methods, apparatus, and articles of manufacture improve the efficiency of using a computing device by using artificial intelligence models to detect locations of performers using image sensors, as opposed to more complicated approaches such as pressure sensors embedded into a performance area. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture for real-time interactive performances are disclosed herein. Further examples and combinations thereof include the following:

Example 1 includes an apparatus for a real-time interactive performance, the apparatus comprising at least one memory, machine readable instructions, and processor circuitry to at least one of instantiate or execute the machine readable instructions to capture an image of a performance area, detect one or more performers in the performance area using the captured image, estimate locations of the one or more detected performers, smooth the estimated locations of the one or more detected performers based on prior estimated locations, and provide the smoothed estimated locations to display controller circuitry for generation of an interactive effect based on the smoothed estimated locations.

Example 2 includes the apparatus of example 1, wherein the processor circuitry is further to compensate the estimated locations to account for latency.

Example 3 includes the apparatus of example 1, wherein to estimate the locations of the one or more detected performers, the processor circuitry is to apply a homograph matrix to translate from a pixel location within the image to a physical location in the performance area.

Example 4 includes the apparatus of example 1, wherein to estimate the locations of the one or more detected performers, the processor circuitry is to generate bounding boxes corresponding to each of the detected one or more performers.

Example 5 includes the apparatus of example 4, wherein the estimation of the locations of the one or more detected performers is based on locations of midpoints of lower edges of the bounding boxes.

Example 6 includes a system for real-time interactive performances, the system comprising first position detection circuitry to estimate positions of performers in a first zone of a performance area, second position detection circuitry to estimate positions of performers in a second zone of the performance area, and the display controller circuitry to aggregate the positions of the performers estimated by the first position circuitry and the second position detection circuitry and generate an interactive effect based on the aggregated positions.

Example 7 includes the system of example 6, wherein the first zone of the performance area is adjacent the second zone of the performance area.

Example 8 includes the system of example 7, wherein the display controller circuitry is to, in response to a determination that two estimated positions are within a threshold distance of each other, remove one of the two estimated positions.

Example 9 includes the system of example 8, wherein the display controller circuitry is only to remove the one of the two estimated positions when the position is within an overlap region.

Example 10 includes a non-transitory machine readable storage medium comprising instructions that, when executed, cause processor circuitry to at least capture an image of a performance area, detect one or more performers in the performance area using the captured image, estimate positions of the one or more detected performers, smooth the estimated positions of the one or more detected performers, and provide the smoothed estimated positions to display controller circuitry for generation of an interactive effect based on the smoothed estimated positions.

Example 11 includes the non-transitory machine readable storage medium of example 10, wherein the processor circuitry is further to compensate the estimated positions to account for latency.

Example 12 includes the non-transitory machine readable storage medium of example 10, wherein to estimate the positions of the one or more detected performers, the processor circuitry is to apply a homograph matrix to translate from a pixel location within the image to a physical location in the performance area.

Example 13 includes the non-transitory machine readable storage medium of example 10, wherein to estimate the positions of the one or more detected performers, the processor circuitry is to generate bounding boxes corresponding to each of the detected one or more performers.

Example 14 includes the non-transitory machine readable storage medium of example 13, wherein the estimation of the positions of the one or more detected performers is based on locations of midpoints of lower edges of the bounding boxes.

Example 15 includes a method for real-time interactive performances, the method comprising capturing an image of a performance area, detecting, by executing an instruction with at least one processor, one or more performers in the performance area using the captured image, estimating positions of the one or more detected performers, smoothing the estimated positions of the one or more detected performers based on prior estimated locations, and providing the smoothed estimated positions to display controller circuitry for generation of an interactive effect based on the smoothed estimated positions.

Example 16 includes the method of example 15, further including compensating the estimated positions to account for latency.

Example 17 includes the method of example 15, further including, to estimate the positions of the one or more detected performers, applying a homograph matrix to translate from a pixel location within the image to a physical location in the performance area.

Example 18 includes the method of example 15, further including, to estimate the positions of the one or more detected performers, generating bounding boxes corresponding to each of the detected one or more performers.

Example 19 includes the method of example 18, wherein the estimation of the positions of the one or more detected performers is based on locations of midpoints of lower edges of the bounding boxes.

Example 20 includes an apparatus for real-time interactive performances, the apparatus comprising means for capturing an image of a performance area, means for detecting or more performers in the performance area using the captured image, means for estimating positions of the one or more detected performers, means for smoothing the estimated positions of the one or more detected performers based on prior estimated locations, and means for providing the smoothed estimated positions to display controller circuitry for generation of an interactive effect based on the smoothed estimated positions.

Example 21 includes the apparatus of example 20, further including means for compensating the estimated positions to account for latency.

Example 22 includes the apparatus of example 20, wherein the means for estimating is further to apply a homograph matrix to translate from a pixel location within the image to a physical location in the performance area.

Example 23 includes the apparatus of example 20, wherein the means for estimating is further to generate bounding boxes corresponding to each of the detected one or more performers.

Example 24 includes the apparatus of example 23, wherein the estimation of the positions of the one or more detected performers is based on locations of midpoints of lower edges of the bounding boxes.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus for a real-time interactive performance, the apparatus comprising:
at least one memory;
machine readable instructions; and
processor circuitry to at least one of instantiate or execute the machine readable instructions to:
capture an image of a performance area;
detect one or more performers in the performance area using the captured image;
estimate locations of the one or more detected performers;
smooth the estimated locations of the one or more detected performers based on prior estimated locations; and
provide the smoothed estimated locations to display controller circuitry for generation of an interactive effect based on the smoothed estimated locations.

2. The apparatus of claim 1, wherein the processor circuitry is further to compensate the estimated locations to account for latency.

3. The apparatus of claim 1, wherein to estimate the locations of the one or more detected performers, the processor circuitry is to apply a homograph matrix to translate from a pixel location within the image to a physical location in the performance area.

4. The apparatus of claim 1, wherein to estimate the locations of the one or more detected performers, the processor circuitry is to generate bounding boxes corresponding to each of the detected one or more performers.

5. The apparatus of claim 4, wherein the estimation of the locations of the one or more detected performers is based on locations of midpoints of lower edges of the bounding boxes.

6. The apparatus of claim 1, further including the display controller circuitry, wherein the display controller circuitry includes:
first position detection circuitry to estimate positions of performers in a first zone of a performance area;
second position detection circuitry to estimate positions of performers in a second zone of the performance area; and
the display controller circuitry to aggregate the positions of the performers estimated by the first position circuitry and the second position detection circuitry and generate an interactive effect based on the aggregated positions.

7. The apparatus of claim 6, wherein the first zone of the performance area is adjacent the second zone of the performance area.

8. The apparatus of claim 7, wherein the display controller circuitry is to, in response to a determination that two estimated positions are within a threshold distance of each other, remove one of the two estimated positions.

9. The apparatus of claim 8, wherein the display controller circuitry is only to remove the one of the two estimated positions when the position is within an overlap region.

10. A non-transitory machine readable storage medium comprising instructions that, when executed, cause processor circuitry to at least:
capture an image of a performance area;
detect one or more performers in the performance area using the captured image;
estimate positions of the one or more detected performers;
smooth the estimated positions of the one or more detected performers; and
provide the smoothed estimated positions to display controller circuitry for generation of an interactive effect based on the smoothed estimated positions.

11. The non-transitory machine readable storage medium of claim 10, wherein the processor circuitry is further to compensate the estimated positions to account for latency.

12. The non-transitory machine readable storage medium of claim 10, wherein to estimate the positions of the one or more detected performers, the processor circuitry is to apply a homograph matrix to translate from a pixel location within the image to a physical location in the performance area.

13. The non-transitory machine readable storage medium of claim 10, wherein to estimate the positions of the one or more detected performers, the processor circuitry is to generate bounding boxes corresponding to each of the detected one or more performers.

14. The non-transitory machine readable storage medium of claim 13, wherein the estimation of the positions of the one or more detected performers is based on locations of midpoints of lower edges of the bounding boxes.

15-19. (canceled)

20. An apparatus for real-time interactive performances, the apparatus comprising:
means for capturing an image of a performance area;
means for detecting or more performers in the performance area using the captured image;
means for estimating positions of the one or more detected performers;
means for smoothing the estimated positions of the one or more detected performers based on prior estimated locations; and
means for providing the smoothed estimated positions to display controller circuitry for generation of an interactive effect based on the smoothed estimated positions.

21. The apparatus of claim 20, further including means for compensating the estimated positions to account for latency.

22. The apparatus of claim 20, wherein the means for estimating is further to apply a homograph matrix to translate from a pixel location within the image to a physical location in the performance area.

23. The apparatus of claim 20, wherein the means for estimating is further to generate bounding boxes corresponding to each of the detected one or more performers.

24. The apparatus of claim 23, wherein the estimation of the positions of the one or more detected performers is based on locations of midpoints of lower edges of the bounding boxes.
